(19) United States
(12) Patent Application Publication
(10) Pub. No.: US 2005/0101497 A1
(43) Pub. Date: May 12, 2005

(54) Compositions and methods for improved friction durability in power transmission fluids

(76) Inventors: Lee D. Saathoff, Glen Allen, VA (US); Samuel H. Tersigni, Glen Allen, VA (US); Kenji Yatsunami, Tokyo (JP)

Correspondence Address: DENNIS H. RAINEAR, CHIEF PATENT COUNSEL, ETHYL CORPORATION, 330 SOUTH FOURTH STREET, RICHMOND, VA, 23219, US

(21) Appl. No.: 10/705,992

(22) Filed: Nov. 12, 2003

(51) Int. Cl. C10M 129/16; G01N 19/02

(52) U.S. Cl. 508/579; 508/291; 508/542; 73/10

(57) ABSTRACT

The present invention discloses friction modifier compositions, methods for incorporating an alkoxylated alcohol component in power transmission fluids, and methods for measuring friction performance. These formulations and methods provide improved overall friction and improved friction durability, yielding effective fluids that are stable with age. Benefits in friction modification may also be achieved when the alkoxylated alcohol component is heated with an ashless dispersant prior to its incorporation into a transmission fluid.

### FIELD

The present invention relates to transmission fluid compositions and methods for incorporating an alkoxylated alcohol component in power transmission fluids that provide high overall friction and improved friction durability, yielding effective transmission fluids that are stable with age and operating stresses. The present invention also relates to methods for measuring friction performance of a power transmission fluid.

### BACKGROUND

Power transmission fluids must serve many functions, including the capability to provide sufficient coefficients of friction for friction plates, and in the case of a continuously variable transmission (CVT), the proper steel-on-steel coefficient of friction.

Considerable effort has been devoted to the provision of oil-soluble additive formulations for use in power transmission fluids, and in particular those for automatic transmissions and CVTs. Friction modifiers have frequently been used in such formulations to modify the shape of the “friction vs. sliding speed” curve (the μ-v curve), in general, to make it more positive. One disadvantage of many friction modifiers is that they typically deteriorate with thermal and chemical stresses. This can lead to shudder in slipping torque converters, in lock-up torque converters, in shifting clutches, in clutch-to-clutch transmissions, and in transmissions with wet starting clutches. It can also lead to instability in measures of dynamic friction in three-, four-, five-, six-, or seven-speed transmissions, and in CVTs (chain, belt, or toroidal disk type). There is a need for a highly stable friction modifier as an additive in a power transmission fluid that would extend its useful life.

### BRIEF DESCRIPTION OF EMBODIMENTS

The present invention discloses the novel use of an alkoxylated alcohol, both as an independent additive or in conjunction with one or more other additives, as a friction modifier that resists deterioration and achieves improved friction and friction durability. Further, the power transmission fluids of the present disclosure provide improved or lower static friction while maintaining dynamic friction, thus controlling (or decreasing) friction in a stable manner.

In an embodiment, a power transmission fluid having improved friction properties, may comprise a major amount of a base oil and a minor amount of at least one alkoxylated alcohol.

In another embodiment, a power transmission may comprise a dispersant and an alkoxylated alcohol having at least 8 carbon atoms.

In another embodiment, a method of making a power transmission fluid having friction modifying capabilities may comprise adding to a major amount of a base oil a minor amount of at least one alkoxylated alcohol.

In another embodiment, a method of making a power transmission fluid concentrate having improved friction modifying properties may comprise combining at least one alkoxylated alcohol and a dispersant and heating the alkoxylated alcohol and the dispersant at a temperature between about 25° C. and about 200° C. for a time between about 0.1 to about 196 hours.

In another embodiment, a method of making a power transmission fluid may comprise combining an alkoxylated alcohol with a dispersant and forming a mixture, heating the mixture, and adding the mixture to a base oil.

In another embodiment, a method of making a power transmission fluid may comprise combining an alkoxylated alcohol with a dispersant and forming a mixture, and adding the mixture to a base oil.

In another embodiment, a method of measuring friction performance of a power transmission fluid using an LFW-1 apparatus may comprise the steps of: applying a first power transmission fluid between a block and ring of an LFW-1 test apparatus; rotating the ring relative to the block from a velocity of about 0 m/s to about 0.5 m/s in about 40 seconds at a constant rate of acceleration and then rotating the ring relative to the block from a velocity of about 0.5 m/s to about 0 m/s at a constant rate of deceleration to provide a cycle; and measuring friction between the block and ring during the cycle.

In another embodiment, a method of selecting a power transmission fluid may comprise the method of measuring friction performance described herein, further comprising selecting a power transmission fluid by comparing the friction durability of the first power transmission fluid and the second power transmission fluid.

### BRIEF DESCRIPTION OF THE DRAWINGS

FIG. 1(A) illustrates friction profiles for samples tested in a LFW-1 test according to some embodiments of the present disclosure.

FIG. 1(B) illustrates friction profiles for samples tested in a LFW-1 test according to some embodiments of the present disclosure.

FIG. 2 illustrates friction profiles for samples tested in a LFW-1 test according to some embodiments of the present disclosure.

FIG. 3 illustrates friction profiles for samples tested in a LFW-1 test according to some embodiments of the present disclosure.

### DETAILED DESCRIPTION OF EMBODIMENTS

Novel compositions for enhancing friction and friction durability in power transmission fluids, and also methods for making and using these compositions are presented herein. The power transmission fluids of the present disclosure may comprise a major amount of base oil and a minor amount of an alkoxylated alcohol or mixture of alkoxylated alcohols. The present compositions achieve improved performance and friction durability in power transmission fluids through the incorporation of an alkoxylated alcohol component, which enhances the life of a transmission fluid that is subjected to oxidative and thermal degradation conditions during normal service.

The present embodiments overcome previous difficulties in achieving enhanced friction performance and overall utility of a power transmission fluid over long periods of time.

The alkoxylated alcohol friction modifiers useful in certain embodiments of the present disclosure are represented by the general formula:
R-[O—CH₂)_{X}]_{Y}—OH
wherein R may be a linear, branched, or cyclic aliphatic hydrocarbon group having from about 1 to about 50 carbon atoms, X may range from about 1 to about 10, and Y may range from about 1 to about 10. In an embodiment, R may be a hydrocarbon group having from about 3 to about 40 carbon atoms, or as a further embodiment, from about 8 to about 18 carbon atoms. In an embodiment, X may range from about 2 to about 4, and Y may range from about 1 to about 6.

As used herein, a “power transmission fluid” or “transmission fluid” may include a lubricant useful for contact with gears involved in the transmission of mechanical energy, including in transmissions that may contain a slipping torque converter, a lock-up torque converter, a starting clutch, and/or one or more shifting clutches. Such transmissions may include a three-, four-, five-, six-, or seven-speed transmission, or a continuously variable transmission (chain, belt, or toroidal disk type) or a manual or an automatic transmission.

In an embodiment, the present invention achieves improved friction performance and durability of friction performance in power transmission fluids through the incorporation of an alkoxylated alcohol friction modifier component that is both effective and stable over a long period of time. It is contemplated that the alkoxylated alcohol component may comprise one species of a particular alkoxylated alcohol (e.g., ethoxylated lauryl alcohol, or “ELA”), or a mixture of alkoxylated alcohols within the scope of the present disclosure.

In an embodiment of the present invention, the alkoxylated alcohol component may be added to a power transmission fluid as one constituent in an overall formulation. In another embodiment, alkoxylated alcohol may be added to the power transmission fluid in conjunction with another transmission fluid additive, such as a dispersant. In an embodiment of the invention, the alkoxylated alcohol is added to the transmission fluid or to the additive package with no processing or reacting. In another embodiment, the alkoxylated alcohol is first heated with an ashless dispersant and the resulting mixture is then added to the transmission fluid or additive package.

In an embodiment, the additives provided by this disclosure provide for the incorporation of an alkoxylated alcohol component to a power transmission fluid at room temperature, and at no particular interval in the processing sequence. Once prepared, this novel additive imparts improved friction characteristics, and importantly, provides these benefits over the life of the fluid. Another embodiment provides for the combining and heating of the alkoxylated alcohol component with a dispersant prior to incorporation of the mixture in the power transmission fluid. The dispersant may contain either or both phosphorus and boron, or neither phosphorous nor boron.

As described herein, dispersants may comprise ashless dispersants and/or may include at least one nitrogen-containing ashless dispersant such as, for example, but not limited to: a hydrocarbyl-substituted succinimide, a hydrocarbyl-substituted succinic acid, a hydrocarbyl-substituted succinamide, a hydrocarbyl-substituted succinic ester/amide, a long-chain amine, a Mannich-type ashless dispersant, and the like. Typical hydrocarbyl succinimides are disclosed in the following U.S. patents: U.S. Pat. No. 3,018,247; U.S. Pat. No. 4,554,086; and U.S. Pat. No. 4,857,214, herein incorporated by reference. Mixed ester-amides of hydrocarbyl-substituted succinic acids using alkanols, amines, and/or aminoalkanols are described, for example, in U.S. Pat. No. 4,234,435. The use and preparation of hydrocarbyl-substituted succinic acid esters and succinic acid salts are disclosed, for example, in U.S. Pat. No. 3,275,554; U.S. Pat. No. 3,454,555; and U.S. Pat. No. 3,565,804, herein incorporated by reference. Typical Mannich-type ashless dispersants that can be used in the practice of this invention include those disclosed in U.S. Pat. No. 3,368,972; U.S. Pat. No. 3,703,536; and U.S. Pat. No. 3,803,039, herein incorporated by reference.

The dispersant used in an embodiment of the present disclosure may comprise hydrocarbyl succinimides in which the hydrocarbyl substituent is a hydrogenated or unhydrogenated polyolefin group; and in a particular embodiment, a polyisobutylene group having a number average molecular weight (measured by gel permeation chromatography) ranging from about 700 to about 10,000, and in another embodiment ranging from about 700 to about 5,000, and in another embodiment ranging from about 750 to about 2,500. The overall amount of dispersant used in an embodiment may range from about 0.01 wt % to about 15 wt %, or as another example, from about 0.01 wt % to about 10 wt %. In another embodiment, the amount of dispersant used in a power transmission fluid may range from about 1 wt % to about 8 wt %. Another embodiment may include the dispersant at ranges from about 2 wt % to about 6 wt %.

A process for preparing the transmission fluid additives may comprise combining in any sequence an alkoxylated alcohol or mixture of alkoxylated alcohols with a transmission fluid. Another embodiment may include a process that comprises combining in any sequence an alkoxylated alcohol or mixture of alkoxylated alcohols with a dispersant and heating at a temperature that ranges between about 20° C. and about 200° C. for a time ranging from about 0.1 to about 196 hours. As a further example, the combination may be heated at about 60° C. to about 170° C. As an even further example, the combination may be heated for about 0.5 to about 24 hours. In an embodiment, the dispersant may be treated with a boron- and/or a phosphorus-containing compound either prior to, concurrently, or following the addition of the alkoxylated alcohol component.

In an embodiment, the concentration of the alkoxylated alcohol component in the finished transmission fluid may range from about 0.01 wt % to about 20 wt %, as a further example, from about 0.05 wt % to about 10 wt %, as an even further example, from about 0.1 wt % to about 6 wt %, and as an even further example, from about 0.1 wt % to about 3 wt %. In an embodiment in which the ashless dispersant is combined with the alkoxylated alcohol prior to adding the combination to the transmission fluid, the concentration of alkoxylated alcohol reacted previously with the dispersant may range from about 0.001 wt % to about 50 wt %. In another embodiment, the overall concentration of the dispersant reacted with alkoxylated alcohol in the transmission fluid may range from about 0.01 wt % to about 20 wt %, to about 15 wt %, or to about 10 wt %.

Base or lubricating oils contemplated in preparing the power transmission fluids of the present invention may be derived from natural lubricating oils, synthetic lubricating oils, and mixtures thereof. Other suitable base oils may include gas to liquid base oils, and/or any base oil classified as Group I, II, III, IV, or V. In general, the base oil used in the present invention may have a kinematic viscosity at 100° C. ranging from about 1.0 to about 100.0 cSt, and as a further example, from about 1.0 to about 15.0 cSt, and as an even further example from about 1.5 to about 10 cSt. Natural lubricating oils include animal oils, vegetable oils, petroleum oils, mineral oils, and oils derived from coal and shale. Mineral oils include all common mineral oil basestocks, such as naphthenic or paraffinic oils, and may have kinematic viscosities at 100° C. ranging from about 0.5 to about 20.0 cSt, and as a further example, from about 1.5 to about 15 cSt. Synthetic oils include hydrocarbon oils and halo-substituted hydrocarbon oils, such as oligomerized, polymerized, and interpolymerized olefins and alkylated diphenyl ethers, alkylated diphenyl sulfides, as well as their derivatives, analogs and homologs. Synthetic oils also include alkylene oxide polymers, interpolymers, copolymers, and derivatives thereof where the terminal hydroxyl groups have been modified by esterification, etherification, etc. Another class of synthetic lubricating oils includes the esters of dicarboxylic acids with a variety of alcohols. Silicon-based oils may also be utilized, as may liquid esters of phosphorus-containing acids, polymeric tetrahydrofurans, poly-alpha olefins, and the like. Lubricating oils may be also be derived from unrefined sources, refined oils, rerefined oils, and mixtures thereof.

In addition to the alkoxylated alcohol component, which may be optionally heated and added with an ashless dispersant, the power transmission fluid formulations of the present invention may include other optional components. These components may include other friction modifiers, dispersants, detergents, seal swell agents, antiwear agents, extreme pressure agents, antioxidants, foam inhibitors, lubricity agents, rust inhibitors, corrosion inhibitors, demulsifiers, viscosity improvers, dyes and the like. The embodiments of the present invention have been found to be effective when used in conjunction with various additives, including, for example, with and without boronated agents.

Nitrogen-containing ashless dispersants are well known as lubricating oil additives. Suitable ashless dispersants that may be used in the present invention include hydrocarbyl succinimides, hydrocarbyl succinamides, mixed ester/amides of hydrocarbyl-substituted succinic acid, hydroxyesters of hydrocarbyl-substituted succinic acid, and Mannich condensation products of hydrocarbyl-substituted phenols, formaldehyde and amines. Also suitable in the present invention may be condensation products of polyamines and hydrocarbyl-substituted phenyl acids. Mixtures of any of these dispersants may also be used.

Another embodiment comprises a method of measuring friction performance of a power transmission fluid using an LFW-1 block on ring test apparatus. The method comprises applying fluids between the block and ring of the LFW-1 test apparatus. The ring is rotated relative to the block in cycles of acceleration for about 40 sec from about 0 to about 0.5 m/sec and then deceleration from about 0.5 to about 0 m/sec at about 121° C. The friction between the block and ring during the cycle are measured to provide about 50 or more measurements, or as a further example about 100 or more measurements, or as an even further example, about 2800 or more measurements. A cycle may be repeated any number of times, for example, about 1 to about 50 times. The method may be used to measure the friction performance of a new power transmission fluid or an aged power transmission fluid to provide friction durability. To age a power transmission fluid, the fluid may be subject to an oxidation bath for 100 hours at 170° C. The resulting friction performance measurements or friction durability may then be compared. Two or more different power transmission fluids may be so tested and then the friction performance measurements or friction durability compared. A power transmission fluid may be selected for a particular power transmitting application, such as a transmission or torque converter disclosed herein, based on the comparison of the resulting measurements. As an example, the friction performance or friction durability of a power transmission fluid comprising an alkoxylated alcohol may be compared to a power transmission fluid free of an alkoxylated alcohol. As an even further example, the friction performance or friction durability of a power transmission fluid comprising an alkoxylated alcohol may be compared to a power transmission fluid comprising a different alkoxylated alcohol.

### EXAMPLES

Transmission fluid formulations were tested and evaluated for effectiveness in modifying friction in accordance with embodiments of the present disclosure.

### Example 1

This example demonstrates the utility of an alkoxylated alcohol additive in modifying friction initially and over time, as disclosed herein. Transmission fluid Formulation (1) was prepared as a control and contained no ELA. Formulation (1) contained an ashless dispersant at 4 wt % that contained both boron and phosphorous. Formulation (2) was prepared with 0.24 wt % ELA added directly to the transmission fluid at room temperature, and also included the ashless dispersant of Formulation (1) at 4 wt %. Formulation (3) was prepared with 6% ELA heated for 4 hours at 120° C. with the ashless dispersant. The combination was then added to the other supplemental additives at an overall concentration of 4 wt % in the finished fluid.

The data shown in Table 1 were acquired using LFW-1 block on ring test apparatus using the test procedures disclosed herein. In particular, the fluids tested were applied between the block and ring of the LFW-1 test apparatus. The ring was rotated relative to the block and measurements were taken in cycles of acceleration for about 40 sec and then deceleration from about 0 to about 0.5 m/sec and back to about 0 at about 121° C. About 2800 measurements were taken per cycle. To obtain friction measurements for an aged formulation, each transmission fluid sample was “aged” for 100 hours at 170° C. using an oxidation bath and subjected to the same testing conditions.

TABLE 1
Effectiveness of Ethoxylated Lauryl Alcohol in Modifying
Friction

| | Static/Dynamic | Static/Dynamic |
|---|---|---|
| | Initial | Aged |
| Formulation (1) | 0.952 | 1.057 |
| Formulation (2) | 0.923 | 1.031 |
| Formulation (3) | 0.924 | 1.024 |

In evaluating the data shown in Table 1, better friction durability is indicated by the ratio of static to dynamic friction being a number less than about 1, such as about 0.92. Thus, both of the formulations containing ELA surpass the control in friction durability, as the measurements for the coefficient of friction durability decrease when ELA is added to the fluid directly (Formulation (2)), and when pre-reacted with the ashless dispersant (Formulation (3)) both initially and after aging (e.g., by heating).

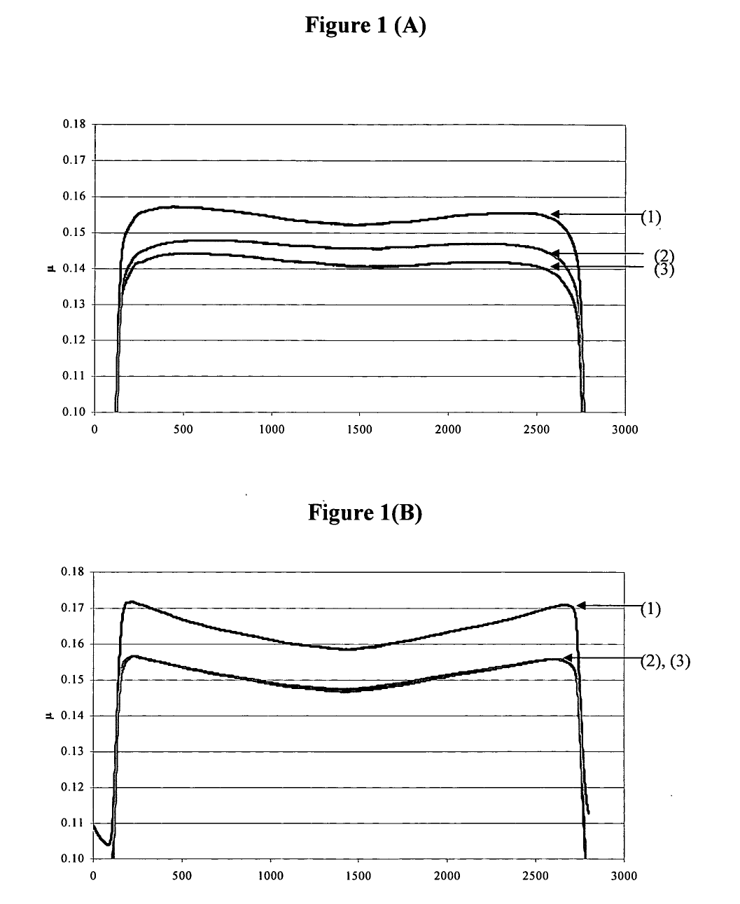

The data acquired during the testing of the formulations in this example are shown diagrammatically in the drawings in FIG. 1(A) (Initial Friction Measurements) and FIG. 1(B) (Aged Measurements) for the three sample formulations described above. Again, lower measurements are indicative of better friction durability; therefore, the curves achieving lower values and less change from FIG. 1(A) on the y-axis were indicative of better results.

Regression analysis of happenstance data from the initial LFW-1 frictional data of power transmission fluids indicated that ELA added to the fluid and ELA pre-mixed with dispersant both lower static/dynamic friction ratios with a greater than 99% probability of significance. Analysis of the frictional data obtained from testing aged fluids in the LFW-1 demonstrated that ELA added to the fluid and ELA pre-mixed with dispersant both lower static/dynamic friction ratios with a greater than 99.9% probability of significance.

### Example 2

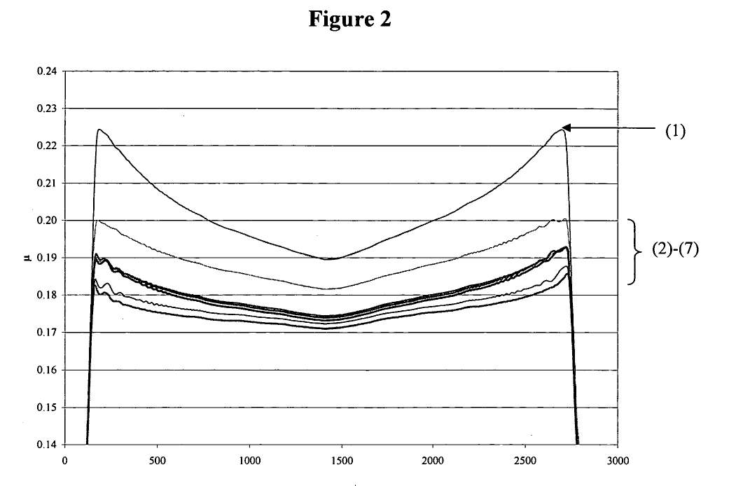

In another example, the LFW-1 test was run using a variety of linear-chain and branched-chain alkoxylated alcohols. The results using Samples #3-7 were compared to Sample #2, a formulation using ELA and to a formulation having no ethoxylated alcohol (Sample #1). In Sample #3, an ethoxylated C10-C12 linear alcohol with an average of 3 ethoxylations per molecule, was used. In Sample #4, an ethoxylated C10-C12 linear alcohol with an average of 5 ethoxylations per molecule, was used. In Sample #5, an ethoxylated C12-C14 linear alcohol with an average of 3 ethoxylations per molecule, was used. In Sample #6, an ethoxylated C8-C10 linear alcohol with an average of 2 ethoxylations per molecule, was used. In Sample #7, an ethoxylated C8-C10 linear alcohol with an average of 4.5 ethoxylations per molecule, was used. The formulations all contained about 4 wt % dispersant. Each formulation was tested both initially and after aging for 100 hours at 170° C. Results for the ratio of static to dynamic friction for new and aged fluid are shown, where a more desirable result is a number less than about 1. These results are also shown diagrammatically in FIG. 2, where the highest curve reflects results obtained from the control (no alkoxylated alcohol) sample, with the remaining curves performing similarly to ELA in friction testing.

Samples 2-7 exhibited better measures of the ratio of static to dynamic friction in comparison with the control (Sample #1). In addition, the varying alkoxylated alcohols tested in this example performed similarly to ELA.

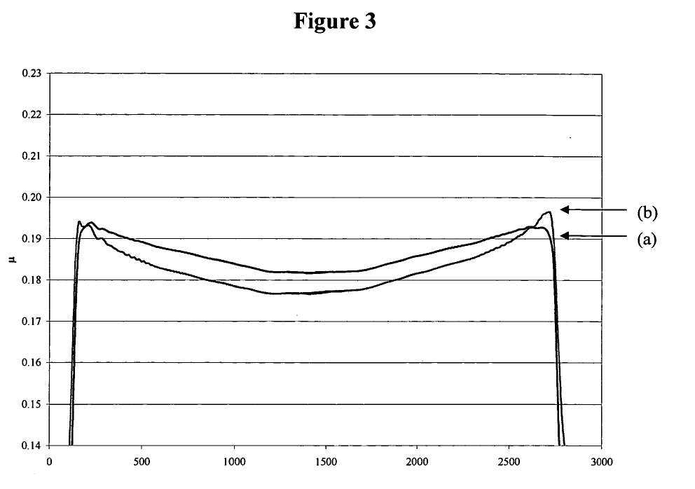

Various branched alkoxylated alcohol samples were also tested and compared to the control sample containing no alkoxylated alcohol. Three formulations were tested which include a mixture of 50% linear and 50% branched alkoxylated alcohols. The results from testing these samples are shown in Table 2, and the results from sample #10 are shown schematically in FIG. 3. In FIG. 3, curve (a) represents friction performance of the fluid when new and (b) represents friction performance of the fluid after aging. Data from an LFW-1 test were obtained using three samples: Sample #8 was a formulation comprising 3 moles of ethylene oxide per mole of alcohol, Sample #9 was a formulation comprising 5 moles of ethylene oxide per mole of alcohol, and Sample #10 was a formulation comprising 7 moles of ethylene oxide per mole of alcohol. The branched alkoxylated alcohol samples achieved comparable results for friction performance to those from the ELA and linear alkoxylated alcohols tested in previous examples.

TABLE 2
Comparison of Alkoxylated Alcohol Formulations

| | Sample | | | | | | | | | |
|---|---|---|---|---|---|---|---|---|---|---|
| | #1 | #2 | #3 | #4 | #5 | #6 | #7 | #8 | #9 | #10 |
| Static/Dynamic | 1.13 | 1.077 | 1.069 | 1.043 | 1.079 | 1.081 | 1.054 | 1.080 | 1.063 | 1.034 |
| Friction | | | | | | | | | | |
| (Initial) | | | | | | | | | | |
| Static/Dynamic | 1.113 | 1.031 | 0.997 | 0.999 | 1.036 | 1.073 | 1.027 | 1.035 | 1.004 | 0.988 |
| Friction | | | | | | | | | | |
| (Aged) | | | | | | | | | | |

### Example 3

In another example, the LFW-1 test was run using samples containing varying amounts of ELA. The samples contained the same components other the varying amount of ELA. All samples included dispersant in the same amount. Sample #1 was a control and contained no ELA. Sample #2 contained 0.24 wt % ELA, Sample #3 contained 0.48 wt % ELA, Sample #4 contained 1.5 wt % ELA, and Sample #5 contained 3.0 wt % ELA. The formulations were tested initially and after aging for 100 hours at 170° C. Results for the ratio of static to dynamic friction for new and aged fluid are shown in Table 3, where a more desirable result is a number less than about 1. The results indicate improving static/dynamic friction ratios in the aged samples as the ELA is present and is increased.

TABLE 3
Comparison of Various Amounts of ELA

| | Sample | | | | |
|---|---|---|---|---|---|
| | #1 | #2 | #3 | #4 | #5 |
| Static/Dynamic | 0.952 | 0.965 | 0.97 | 0.938 | 0.946 |
| Friction | | | | | |
| (Initial) | | | | | |
| Static/Dynamic | 1.057 | 1.034 | 1.01 | 0.958 | 0.914 |
| Friction | | | | | |
| (Aged) | | | | | |

### Example 4

A regression analysis of happenstance data was also performed on samples containing ELA added as a component and ELA pre-reacted with a dispersant using an LVFA Durability test (JASO M349). The data indicated with a greater than 95% probability of significance that the use of ELA is effective in extending durability life of a power transmission fluid including the same. The same analysis showed with a greater than 99% probability that ELA pre-mixed with dispersant also has a positive effect on durability life.

As used throughout the specification and claims, “a” and/or “an” may refer to one or more than one. Unless otherwise indicated, all numbers expressing quantities of ingredients, properties such as molecular weight, percent, ratio, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

While the present disclosure has been described in some detail by way of illustration and example, it should be understood that the embodiments are susceptible to various modifications and alternative forms, and are not restricted to the specific embodiments set forth. It should be understood that these specific embodiments are not intended to limit the invention but, on the contrary, the intention is to cover all modifications, equivalents, and alternatives falling within the spirit and scope of the invention.

The patentees do not intend to dedicate any disclosed embodiments to the public, and to the extent any disclosed modifications or alterations may not literally fall within the scope of the claims, they are considered to be part of the invention under the doctrine of equivalents.

1. A power transmission fluid having improved friction properties, comprising:
(a) a major amount of a base oil; and
(b) a minor amount of at least one alkoxylated alcohol.

2. The fluid of claim 1, wherein the alkoxylated alcohol comprises the formula:
R—[O—(CH₂)_{X}]_{Y}—OH
wherein R is an aliphatic hydrocarbon group having from about 1 to about 50 carbon atoms, X is from about 1 to about 10, and Y is from about 1 to about 10.

3. The fluid of claim 2, wherein R is a hydrocarbon group having from about 8 to about 18 carbon atoms, X is from about 2 to about 4, and Y is from about 1 to about 6.

4. The fluid of claim 2, wherein the aliphatic hydrocarbon is a linear, branched, or cyclic hydrocarbon and is a saturated or unsaturated hydrocarbon.

5. The fluid of claim 1, wherein the amount of alkoxylated alcohol in the fluid is from about 0.01 wt % to about 20 wt %.

6. The fluid of claim 1, wherein the amount of alkoxylated alcohol in the fluid is from about 0.05 wt % to about 6 wt %.

7. The fluid of claim 1, wherein the fluid is suitable for use in a transmission employing one or more of a slipping torque converter, a lock-up torque converter, a starting clutch, and one or more shifting clutches.

8. The fluid of claim 1, wherein the fluid is suitable for use in a belt, chain, or disk-type continuously variable transmission (CVT).

9. The fluid of claim 1, further comprising a dispersant, wherein the dispersant comprises one or more of a hydrocarbyl succinimide, a hydrocarbyl succinamide, a mixture of an ester and an amide of a hydrocarbyl-substituted succinic acid, a hydroxyester of a hydrocarbyl-substituted succinic acid, and a Mannich condensation product of a hydrocarbyl-substituted phenol, a formaldehyde, and an amine.

10. The fluid of claim 9, wherein the concentration of the dispersant in the fluid is from about 0.01 wt % to about 15 wt %.

11. The fluid of claim 1, wherein the improved friction properties comprise improved friction durability and/or improved resistance to oxidative and thermal degradation relative to a fluid free of an alkoxylated alcohol.

12. A power transmission fluid comprising an alkoxylated alcohol having at least eight carbon atoms and a dispersant.

13. A method of making a power transmission fluid having friction modifying capabilities, comprising adding to a major amount of a base oil a minor amount of at least one alkoxylated alcohol.

14. The method of claim 13, wherein the alkoxylated alcohol is represented by the formula:
R—[O—(CH₂)_{X}]_{Y}—OH
where R is an aliphatic hydrocarbon group having from about 1 to about 50 carbon atoms, X is from about 1 to about 10, and Y is from about 1 to about 10.

15. The method of claim 14, wherein R is a hydrocarbon group having from about 8 to about 18 carbon atoms, X is from about 2 to about 4, and Y is from about 1 to about 6.

16. The method of claim 13, wherein the amount of alkoxylated alcohol in the fluid is from about 0.01 wt % to about 10 wt %.

17. The method of claim 16, wherein the amount of alkoxylated alcohol in the fluid is from about 0.1 wt % to about 3 wt %.

18. The method of claim 13, wherein the base oil comprises one or more of a natural lubricating oil, a synthetic lubricating oil, and mixtures thereof.

19. The method of claim 13, further comprising adding at least one ashless dispersant.

20. A method of making a power transmission fluid concentrate having improved friction modifying properties, comprising:
combining at least one alkoxylated alcohol and a dispersant; and
heating the alkoxylated alcohol and dispersant at a temperature between about 25° C. and about 200° C. for a time from about 0.1 to about 196 hours.

21. The method of claim 20, wherein the alkoxylated alcohol is represented by the formula:
R—[O—(CH₂)_{X}]_{Y}—OH
where R is an aliphatic hydrocarbon group having from about 1 to about 50 carbon atoms, X is from about 1 to about 10, and Y is from about 1 to about 10.

22. The method of claim 21, wherein R is a hydrocarbon group having from about 8 to about 18 carbon atoms, X is from about 2 to about 4, and Y is from about 1 to about 6.

23. The method of claim 20, further comprising adding a minor amount of the power transmission concentrate to a major amount of a base oil, thereby forming a power transmission fluid.

24. The method of claim 20, wherein the dispersant comprises one or more of a hydrocarbyl succinimide, a hydrocarbyl succinamide, a mixture of an ester and an amide of a hydrocarbyl-substituted succinic acid, a hydroxyester of a hydrocarbyl-substituted succinic acid, and a Mannich condensation product of a hydrocarbyl-substituted phenol, a formaldehyde, and an amine.

25. The method of claim 23, wherein the amount of the mixture of alkoxylated alcohol and dispersant in the power transmission fluid is from about 0.01 wt % to about 20 wt %.

26. The method of claim 25, wherein the amount of the mixture of alkoxylated alcohol and ashless dispersant in the power transmission fluid ranges from about 0.01 wt % to about 10 wt %.

27. A method of making a power transmission fluid comprising:
combining an alkoxylated alcohol with a dispersant and forming a mixture;
heating the mixture; and
adding a base oil to the mixture.

28. A method of making a power transmission fluid comprising:
combining an alkoxylated alcohol with a dispersant and forming a mixture; and
adding the mixture to a base oil.

29. An automatic transmission lubricated with the composition of claim 1.

30. An automatic transmission lubricated with the composition of claim 7.

31. The automatic transmission of claim 29 wherein the transmission is a continuously variable transmission.

32. The automatic transmission of claim 30 wherein the transmission is a continuously variable transmission.

33. A method of increasing the duration of friction-modifying capabilities of a power transmission fluid, said method comprising adding to, and operating in, a power transmission a fluid as set forth in claim 1.

34. A method of lubricating a power transmission, comprising adding to, and operating in, a power transmission a fluid as set forth in claim 1.

35. A method of measuring friction performance of a power transmission fluid using an LFW-1 test apparatus, comprising the steps:
applying a first power transmission fluid between a block and ring of an LFW-1 test apparatus;
rotating the ring relative to the block from a velocity of about 0 m/s to about 0.5 m/s in about 40 seconds at a constant rate of acceleration and then rotating the ring relative to the block from a velocity of about 0.5 m/s to about 0 m/s at a constant rate of deceleration to provide a cycle; and
measuring friction between the block and ring during the cycle.

36. The method of claim 35, comprising measuring friction during the cycle to provide about 50 or more measurements.

37. The method of claim 35, comprising measuring friction during the cycle to provide about 100 or more measurements.

38. The method of claim 35, comprising measuring friction during the cycle to provide about 2800 or more measurements.

39. The method of claim 35, comprising repeating the cycle from about 1 to about 50 times.

40. The method of claim 35, wherein the first power transmission fluid is a new fluid.

41. The method of claim 35, wherein the first power transmission fluid is an aged fluid.

42. The method of claim 35, further comprising:
measuring friction of the first power transmission fluid, wherein the first power transmission fluid is a new fluid;
aging the first power transmission fluid to provide an aged first power transmission fluid; and
measuring friction of the aged first power transmission fluid.

43. The method of claim 42, further comprising:
determining friction durability by comparing the measured friction of the aged first power transmission fluid to the new first power transmission fluid.

44. The method of claim 35, comprising:
measuring the friction of a second power transmission fluid, wherein the second power transmission fluid is different from the first power transmission fluid.

45. The method of claim 44, further comprising:
comparing the friction measurements of the first power transmission fluid and the second power transmission fluid; and
selecting the power transmission fluid for a particular power transmitting application based on the measurements.

46. The method of claim 45, wherein the particular power transmitting application comprises one or more of an automatic transmission, a continuously variable transmission, and a torque converter.

47. The method of claim 44, further comprising:
measuring friction of the first power transmission fluid, wherein the first power transmission fluid is a new fluid;
aging the first power transmission fluid to provide an aged first power transmission fluid;
measuring friction of the aged first power transmission fluid;
determining friction durability of the first power transmission fluid by comparing the measured friction of the aged first power transmission fluid to the new first power transmission fluid;
measuring friction of the second power transmission fluid, wherein the second power transmission fluid is a new fluid;
aging the second power transmission fluid to provide an aged second power transmission fluid;
measuring friction of the aged second power transmission fluid; and
determining friction durability of the second power transmission fluid by comparing the measured friction of the aged second power transmission fluid to the new second power transmission fluid.

48. A method of selecting a power transmission fluid for a particular power transmitting application comprising the method of claim 47, further comprising:
selecting a power transmission fluid by comparing the friction durability of the first power transmission fluid and the second power transmission fluid.

49. The method of claim 48, wherein the first power transmission fluid comprises an alkoxylated alcohol and the second power transmission fluid is free of alkoxylated alcohol.

50. The method of claim 48, wherein the first power transmission fluid comprises a first alkoxylated alcohol and the second power transmission fluid comprises a second alkoxylated alcohol, the first alkoxylated alcohol being different from the second alkoxylated alcohol.

51. The method of claim 48, wherein the particular power transmitting application comprises one or more of an automatic transmission, a continuously variable transmission, and a torque converter.
